(19) United States
(12) Patent Application Publication
(10) Pub. No.: US 2021/0133914 A1
(43) Pub. Date: May 6, 2021

(54) MULTIPLE O/S VIRTUAL VIDEO PLATFORM

(71) Applicant: Tactuity LLC, Severna Park, MD (US)

(72) Inventor: Bradford B. Hutson, Vero Beach, FL (US)

(73) Assignee: Tactuity LLC, Severna Park, MD (US)

(21) Appl. No.: 17/084,388

(22) Filed: Oct. 29, 2020

Related U.S. Application Data
(60) Provisional application No. 62/928,609, filed on Oct. 31, 2019.

(51) Int. Cl. G06T 1/20; G06F 9/38; H04N 19/436; G06F 9/4401

(52) U.S. Cl. CPC G06T 1/20; G06F 9/4405; H04N 19/436; G06F 9/3851

(57) ABSTRACT

A virtual multi-Operating System (OS) environment optimized for running multiple image processing applications on a single computing platform using one or more central processing units (CPUs) and one or more graphic processing units (GPUs). According to an exemplary method of video processing, a first video processing application program is operated using a first operating system of a first processor for a computing device. A second video processing application program is simultaneously operated using a second operating system of a second processor for the computing device. Operation of one of the first processor and second processor is dynamically suspended to transfer operation of one of the video processing application programs to the remaining processor.

### CROSS-REFERENCE TO RELATED APPLICATIONS

This application claims priority to U.S. Provisional Application Ser. No. 62/928,609, filed on Oct. 31, 2019, the complete disclosure of which is incorporated herein by reference, in its entirety.

### BACKGROUND

The systems and methods disclosed herein relate generally to a virtual multi-Operating System (OS) environment optimized for running multiple image processing applications on a single computing platform.

### SUMMARY

It is an object of this invention to enable operation of two or more image processing and video management software applications on the same set of embedded processing hardware. In some configurations both central processing unit (CPU) and graphic processing unit (GPU) resources may be used. Sometimes, an operating system (OS), such as an appropriate version of Windows®, may be used simultaneously with another OS, such as LINUX®. In addition, Windows® 10 Security Technical Implementation Guide (STIG) may be followed. Systems and methods herein can resolve cases where there is a conflict between applications for accessing processing, memory, or video capture resources. The present invention can allocate resources virtually and dynamically, based on available resources and bandwidth, for multiple applications running simultaneously and can toggle between each application's functionality and access to resources with minimal latency. Additionally, when a new image processing application is of interest for integration with the multiple OSs and processing hardware, systems and methods herein can add or swap the new operation in and demonstrate functionality, without significant effort or time.

Using the techniques disclosed herein, software applications from multiple suppliers are able to access the same video feed formats and data streams and run on the same CPU/GPU and memory set of hardware in an “open” environment even though some software applications may require direct access to the GPU.

The present invention provides a highly customizable solution that allows different image processing applications running simultaneously on a single hardware solution containing multiple processors (e.g., CPU, GPU, GPGPU, ARM, FPGA, DSP.) It combines open source virtualization with a custom implementation of LINUX® (including various versions such as Ubuntu, Redhat, CentOS, etc.) and Windows® (including all currently supported versions) such that both operating systems are operating simultaneously on the same video stream with minimal latency. It is contemplated that other operating systems such as Android, VX Works, as well as others, may also be used.

An exemplary computer system herein includes a first central processing unit (CPU), a first graphic processing unit (GPU) connected to the first CPU, and a memory connected to the first CPU and the first GPU. The memory contains a first operating system and a second operating system. One of the first CPU and the first GPU operates a first application program using the first operating system as a base operating system. During operation of the first application program, the one of the first CPU and the first GPU suspends operation of the base operating system and dynamically transfers operation of the first application program to the second operating system.

According to an exemplary method of video processing, a first video processing application program is operated using a first operating system of a first processor for a computing device. A second video processing application program is simultaneously operated using a second operating system of a second processor for the computing device. Operation of one of the first processor and second processor is dynamically suspended to transfer operation of one of the video processing application programs to the remaining processor.

According to an exemplary method, a first video processing application program is operated in a computer system having at least one central processing unit (CPU), at least one graphic processing unit (GPU), and memory storing instructions for execution by the at least one CPU and at least one GPU. The instructions include a first operating system and a second operating system. The first video processing application program is operating on the at least one CPU. A second video processing application program is simultaneously operated in the computer system. The second video processing application program is operating on the at least one GPU. Operation of one of the at least one CPU and the at least one GPU is dynamically suspended. The suspended one of the at least one CPU and the at least one GPU is swapped into a storage state in the memory. Operation of the suspended one of the at least one CPU and the at least one GPU is changed to a different operating system. The memory is remapped to the suspended one of the at least one CPU and the at least one GPU. Operation of the one of the at least one CPU and the at least one GPU is resumed using the different operating system.

### BRIEF DESCRIPTION OF THE DRAWINGS

The systems and methods herein will be better understood from the following detailed description with reference to the drawings, which are not necessarily drawn to scale and in which:

FIG. 1 illustrates a processing flow for using multiple processors according to systems and methods herein;

FIG. 2 illustrates memory distribution using multiple processors according to systems and methods herein;

FIG. 3 illustrates a processing flow to transfer operating systems according to systems and methods herein;

FIG. 4 is a flow chart according to systems and methods herein; and

FIG. 5 is a schematic diagram of a hardware system according to systems and methods herein.

### DETAILED DESCRIPTION

According to systems and methods herein, a multiple OS is developed. An open source package such as QEMU (short for Quick EMUlator) may be used. QEMU is a generic and open source machine emulator and virtualizer. When used as a machine emulator, QEMU can run multiple operating systems and programs made for one machine (e.g., an ARM board) on a different machine (e.g., a personal computer). By using dynamic translation, it achieves very good performance.

When used as a virtualizer, QEMU achieves near native performance by executing the guest code directly on the host central processing unit (CPU). QEMU supports virtualization when executing under the Xen hypervisor or using the KVM kernel module in LINUX®. When using KVM, QEMU can virtualize x86, server and embedded PowerPC, 64-bit POWER, S390, 32-bit and 64-bit ARM, and MIPS guests. According to systems and methods herein, several patches and special software may be provided for QEMU to achieve the objectives stated above.

According to systems and methods herein, a multiple OS architecture may be built using LINUX® as the baseline OS with Windows® 10 as a virtual machine. The multiple OS architecture can be used to integrate two image processing applications. In some cases, one image processing application may be LINUX® based and a second image processing application may be Windows® based. The LINUX® based image processing application may use GPU and CPU access, and the Windows® based Video Processor (VP) software may also require access to the CPU and GPU. The present invention may be operated on, for example, an i7 Intel® CPU and NVIDIA GPU with appropriate video capture capability to support the applications. Some versions of the invention may be loaded onto an existing Video Processor (VP) hardware, using existing processing hardware that may include an Intel® i7 CPU, an NVIDIA GPU, and appropriate video capture cards.

In some cases, one image processing application may run on LINUX® and require both CPU and GPU processing resources while a second image processing application may run on Windows®, but only require access to the CPU. For example, some image processing applications may be video compression and encryption software on LINUX® and an image processing application such as video target tracking, DVR/Streaming, or other Windows® based CPU only application.

The invention is a new method to achieve selective GPU allocation with a virtual environment using a base of the publicly available QEMU system. Additional software modules have been written to dynamically switch between and or select the hardware GPU present within a system. As described herein, the virtualization using KVM GPU switching is a mechanism used on computers with multiple graphic controllers that will allow selection of the GPU only upon boot up for the respective OS. In the LINUX® systems, a patch named vga_switcheroo has been added to the LINUX® kernel since version 2.6.34 in order to deal with multiple GPUs. Here, the switch requires a restart of the X Window System to be taken into account.

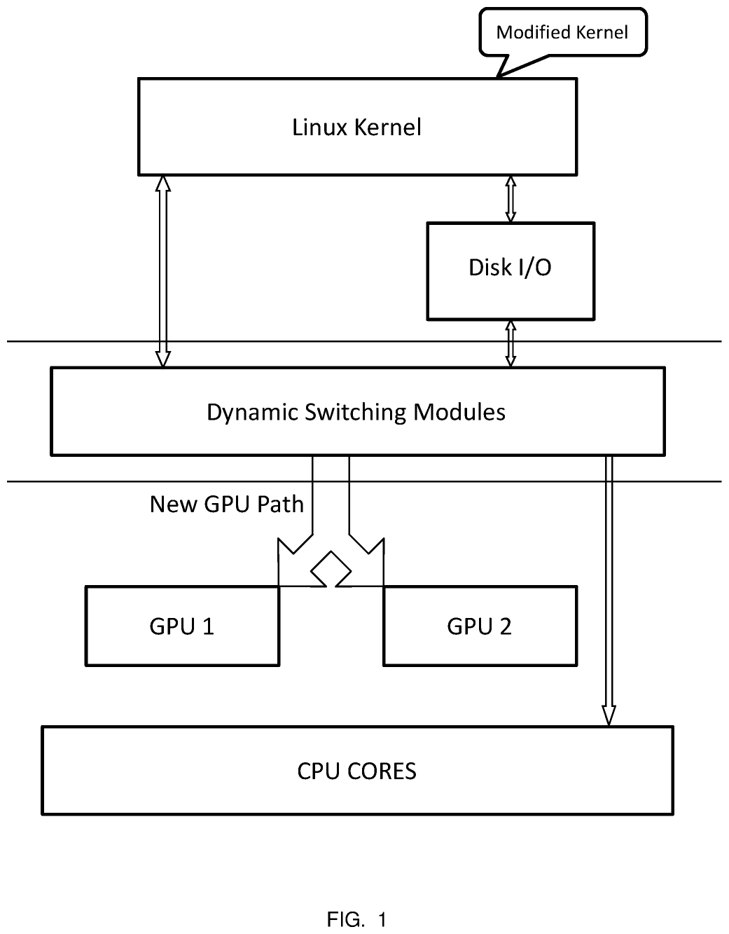

As shown in FIG. 1, systems and methods herein, which consist of specially constructed modules and also base Kernel changes in the host OS allow the selection in real-time of one or the other or both GPUs to utilize in the video processing software without rebooting the core system. This is accomplished by abstracting the GPU hardware and providing software hooks in the GPU memory that map to manipulate the bus to take video graphic data from another source OS. The purpose of this is to optimize video and compression software to operate as though it was on a native platform. The software is not limited to just two GPUs and can control all GPUs within a system. Thus, if the system includes four GPUs, two GPUs can selected at will for one task and two GPUs can be selected for the other, or one GPU for a first task and three GPUs for the other task, or in fact if you have three programs on three virtual OSs you can assign two to one and split the other to the other two. In other words you are free to mix and match GPUs to the task need. This is not specific to video program and could be used for any intense computational needs of the OS in question

In other words, the present invention provides simultaneous operation of different image processing applications running concurrently in a virtual environment, which may, for example be on LINUX® and Windows® operating systems, simultaneously. One image processing application may be run on LINUX® and require both CPU and GPU processing resources. Exemplary applications may include video compression and encryption on LINUX® and an image processing application that requires both the CPU and GPU resources. Both applications do not need to access the GPU simultaneously but may be toggled in their use of the GPU.

Furthermore, the present invention provides simultaneous operation of a customer provided Neural Net image processing application (NNIP) that can be operated in both LINUX® and Windows® operating environments. The NNIP can be instantiated to operate independently in LINUX® and Windows® and share the GPU access through toggling between the applications in using the GPU. While the present disclosure discusses a single CPU and GPU combination, it is contemplated that the present invention is equally applicable for platforms using multiple CPUs and/or multiple GPUs.

Multiple applications may run independently in Windows® and LINUX®. Access to the GPU by each application may be toggled sequentially with minimal latency to be nearly simultaneous. According to systems and methods herein, multiple applications can open in a virtual machine (VM) environment and assigned appropriate resources to maintain operation. When called upon by an operator, for priority operation with either application, the VM will appropriate maximum resources necessary/available while still having other applications running in the background. Use of the GPU may be limited to one application at a time but the VM will support the operator toggling between the applications using the GPU with minimal latency.

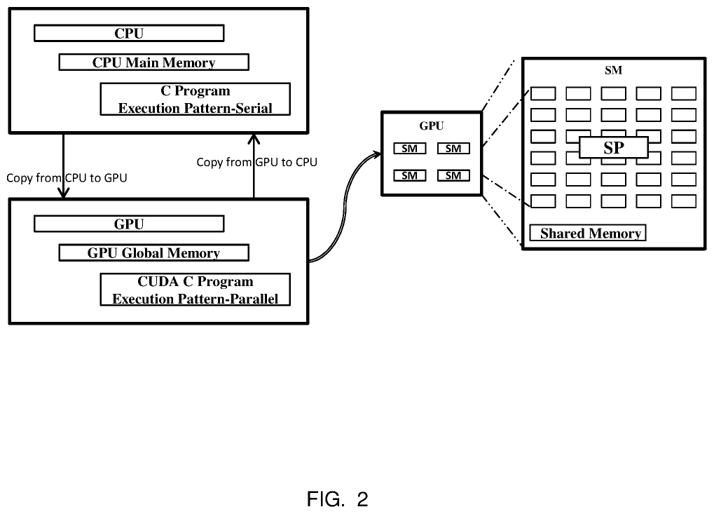

Referring to FIG. 2, a fundamental kernel change is performed to off load the base operation system for a fraction of a second in order to allow the GPU switch to take place. This in effect swaps the entire base OS into a storage state similar to sleeping a system but is done so as to preserve the entire running image in its current state. The entire OS is pushed into RAM for approximately 100 milliseconds and then the memory is remapped to the GPU setup required. The virtualization OSs that have been running are frozen as well and then reinstated with the GPU processing that was allocated to it. The kernel change allows for this to happen without disrupting the memory space of disk Input/Output. Thus the system suddenly performs for the end user as a hardware GPU to be used where there was not one before. The kernel change software is written in the native language of the OS, in this case C, and then the kernel is rebuilt with this added feature built in. In the end the kernel, i.e., LINUX® is not a standard LINUX® core and will not run normal LINUX® software. From that point forward only virtual operating systems can run their respective software, whether it is LINUX®, Windows, or Mac OSX or other X86 based Operating Systems. The additional plug-in modules that are written in C and C++ and complied with the QEMU software stack facilitate the smooth transition of hardware between the virtualization and accelerated OSs that are running. Again, this is accomplished without a system reboot and in most cases with little affect on a running program less a slight pause in processing.

In some embodiments, the kernel can be compiled against the latest source code, as would be known to one of ordinary skill in the art. The software kernel module can be statically linked in to the kernel core. The other modules can be dynamically linked into the modified kernel.

According to systems and methods herein, a baseline OS architecture can be tailored to existing video processor hardware or equivalent, which may be modified by adding an NVIDIA GTX 1050 TI GPU. A third-party supplied Neural Net software package may be integrated to run on both LINUX® and Windows®. In some cases, the GPU access may not be simultaneous, but can be modal.

| Exemplary Software Applications | OS |
|---|---|
| AI, NN, machine vision, edge | LINUX ® or |
| processing application | Windows ® |
| Video Compression and Streaming | LINUX ® |
| Video Encryption | LINUX ® |
| Video Chain-of-Custody | LINUX ® |
| DVR-Streaming | Windows ® |
| 360° Situational Awareness | Windows ® |
| Video target tracking | LINUX ® or |
| | Windows ® |
| Neural net image classification | LINUX ® or |
| | Windows ® |

The systems and methods disclosed herein can be operated on any modern CPU-GPU-GPGPU hardware where different applications are required to run in parallel. The multiple OS can provide unprecedented performance for low SWAP solutions while operating diverse video applications where footprint, power, and access constraints limit image processing solutions.

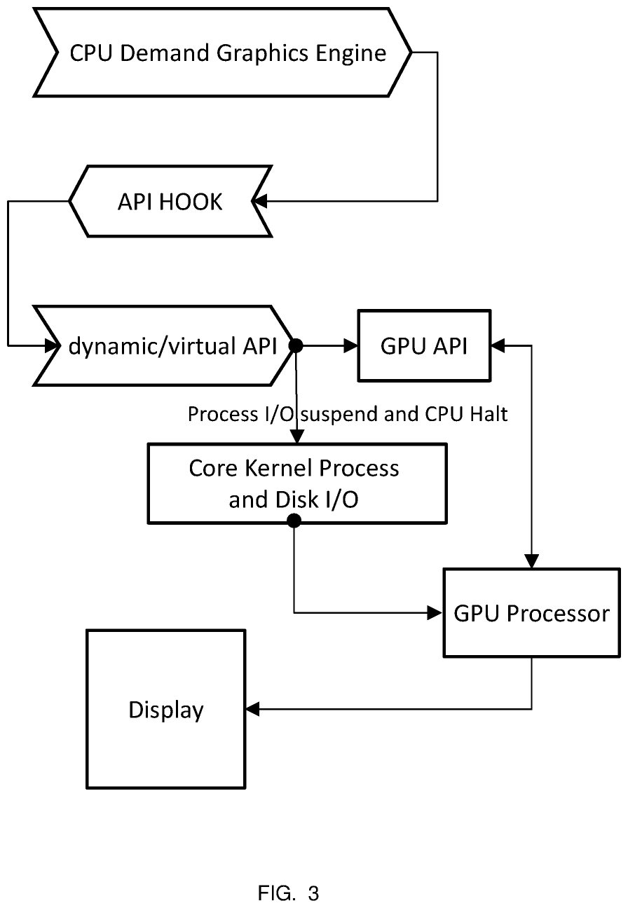

As illustrated in FIG. 3, the modules provide an API hook to allow dynamic programmatic switchable GPUs as well as user electable modes. An automatic feature will determine when a video program requires more Raster. The GPU supports API extensions to the C programming language such as OpenCL and OpenMP. Furthermore, each GPU vendor introduced its own API which only works with their cards, AMD APP SDK and CUDA from AMD and Nvidia, respectively. These technologies allow specified functions called compute kernels from a normal C program to run on the GPUs stream processors. Given that program interfaces with these on a real time bases also allows raster based video functions to utilize additional capabilities beyond the entire GPU being switch entirely. It is the kernel modifications that allow better interaction to these exposed feature and the unique modules to make this seamless to the program and the user. The modifications render the LINUX® kernel unable to process most normal LINUX® programs, in essence it is a new Operating System based on a large core of LINUX®.

The memory and disk changes may also be part of the kernel module as disclosed herein. In some embodiments, SSD disk may be better in handling the switch as they are faster than mechanical drives, but any modern drive will not be adversely affected but the kernel change.

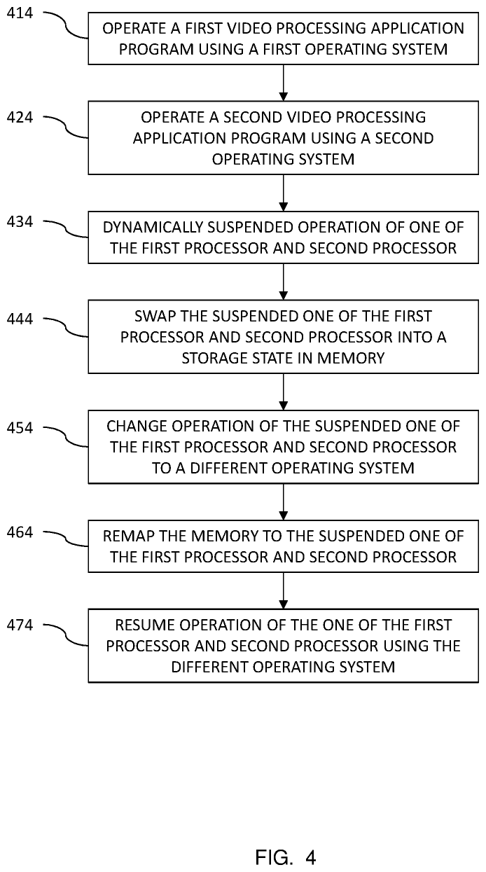

FIG. 4 is a flow diagram illustrating an exemplary method of method of video processing. At 414, a first video processing application program may be operated using a first operating system of a first processor for a computing device. The first processor can be a central processing unit (CPU). At 424, a second video processing application program may be simultaneously operated using a second operating system of a second processor for the computing device. The second processor can be a graphic processing unit (GPU). The first operating system and the second operating system may be selected from the group containing Linux OS, Windows OS, Mac OS, and any other operating system now known or developed in the future.

At 434, operation of one of the first processor and second processor may be dynamically suspended to transfer operation of one of the video processing application programs to the remaining processor. Suspending operation of the one of the first processor and second processor may include suspending operation of its operating system for approximately 100 milliseconds. At 444, the suspended one of the first processor and second processor may be swapped into a storage state in memory. Operation of the video processing application program may be preserved while swapping. At 454, operation of the suspended one of the first processor and second processor may be changed to a different operating system. At 464, the memory may be remapped to the suspended one of the first processor and second processor. At 474, operation of the one of the first processor and second processor may be resumed using the different operating system.

Features
Each image processing application runs at approximately 98% native speed.
Supported versions may include Redhat, CentOS, Ubuntu versions of LINUX® and Windows® IOT.
Operating system(s) can be locked down for information assurance.
Communications with computing machines emulate standard communications as if two separate computing machines exist.
Split use of GPU core processors, cache, and memory from each application.
Switching of processing resources based on compute requirements.
Dynamic switching of CPU/GPU cores, cache and memory allocations to adjust automatically to processing requirements (future option).

Advantages
Run multiple image processing applications simultaneously optimized for real-time on a single set of processing hardware.
Communications with computing machines emulate standard communications as though two separate computing machines exist.
Direct video pass thru display buffer to multiple monitors or to picture in picture.
Split use of GPU core processors, cache and memory from each application.
Dynamic switching of CPU and GPU cores, cache and memory allocations to adjust automatically to processing requirements (future option).
Retention of information assurance and OS lockdown with added layer of cyber protection.
Highly customizable.

Aspects of the present disclosure are described herein with reference to flowchart illustrations and/or block diagrams of methods, apparatus (systems), and computer program products according to various systems and methods. It will be understood that each block of the flowchart illustrations and/or two-dimensional block diagrams, and combinations of blocks in the flowchart illustrations and/or block diagrams, can be implemented by computer program instructions. The computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

According to further systems and methods herein, an article of manufacture is provided that includes a tangible computer readable medium having computer readable instructions embodied therein for performing the steps of the methods, including, but not limited to, the methods illustrated herein. Any combination of one or more computer readable non-transitory medium(s) may be utilized. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. Any of these devices may have computer readable instructions for carrying out the steps of the methods described above.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In case of implementing the systems and methods herein by software and/or firmware, a program constituting the software may be installed into a computer with dedicated hardware, from a storage medium or a network, and the computer is capable of performing various functions if with various programs installed therein.

It is expected that any person skilled in the art can implement the disclosed procedure on a computer and verify the emergent scoring curve for various realizations of the parameters in this example model. The generalization of the procedure to real-world scenarios with other definitions for the similarity measure should be evident to any person skilled in the art.

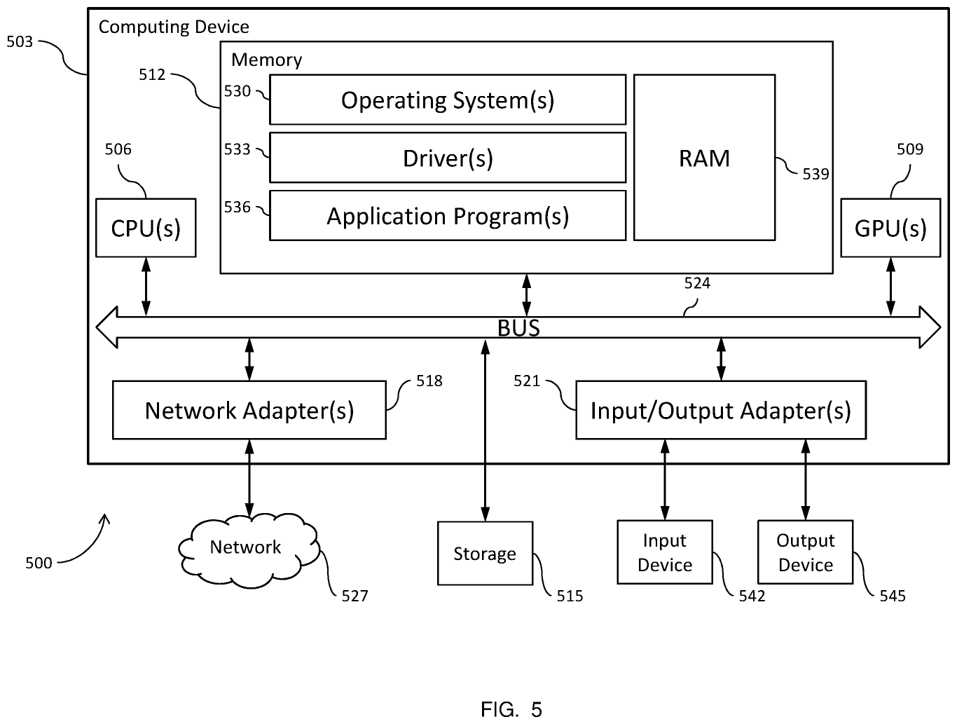

A representative electronic device for practicing the systems and methods described herein is depicted in FIG. 5. This schematic drawing illustrates a hardware configuration of an information handling/computing system 500 in accordance with systems and methods herein. The computing system 500 comprises a computing device 503 having two or more processors, such as central processing unit (CPU) 506 and graphic processing unit (GPU) 509, internal memory 512, storage 515, one or more network adapters 518, and one or more Input/Output adapters 521. A system bus 524 connects the CPU 506 and GPU 509 to various devices such as the internal memory 512, which may comprise Random Access Memory (RAM) and/or Read-Only Memory (ROM), the storage 515, which may comprise magnetic disk drives, optical disk drives, a tape drive, etc., the one or more network adapters 518, and the one or more Input/Output adapters 521. Various structures and/or buffers (not shown) may reside in the internal memory 512 or may be located in a storage unit separate from the internal memory 512.

The one or more network adapters 518 may include a network interface card such as a LAN card, a modem, or the like to connect the system bus 524 to a network 527, such as the Internet. The network 527 may comprise a data processing network. The one or more network adapters 518 perform communication processing via the network 527.

The internal memory 512 stores appropriate Operating Systems 530 and may include one or more drivers 533 (e.g., storage drivers or network drivers). The internal memory 512 may also store one or more Application Programs 536 and include a section of Random Access Memory (RAM) 539. The Operating Systems 530 control transmitting and retrieving packets from remote computing devices (e.g., host computers, database storage systems, etc.) over the network 527. The driver(s) 533 execute in the internal memory 512 and may include specific commands for the network adapter 518 to communicate over the network 527. Each network adapter 518 or driver 533 may implement logic to process packets, such as a transport protocol layer to process the content of messages included in the packets that are wrapped in a transport layer, such as Transmission Control Protocol (TCP) and/or Internet Protocol (IP).

The storage 515 may comprise an internal storage device or an attached or network accessible storage. Storage 515 may include disk units and tape drives, or other program storage devices that are readable by the system. A removable medium, such as a magnetic disk, an optical disk, a magneto-optical disk, a semiconductor memory, or the like, may be installed on the storage 515, as necessary, so that a computer program read therefrom may be installed into the internal memory 512, as necessary. Programs in the storage 515 may be loaded into the internal memory 512 and executed by the CPU 506 and/or GPU 509. The Operating Systems 530 can read the instructions on the program storage devices and follow these instructions to execute the methodology herein.

The Input/Output adapter 521 can connect to peripheral devices, such as input device 542 to provide user input to the CPU 506 and/or GPU 509. The input device 542 may include a keyboard, mouse, pen-stylus, microphone, touch sensitive display screen, or any other suitable user interface mechanism to gather user input. An output device 52745 can also be connected to the Input/Output adapter 521 and is capable of rendering information transferred from the CPU 506 and/or GPU 509, or other component. The output device 52745 may include a display monitor (such as a Cathode Ray Tube (CRT), a Liquid Crystal Display (LCD), or the like), printer, speaker, etc.

The computing system 500 may comprise any suitable computing device 503, such as a mainframe, server, personal computer, workstation, laptop, handheld computer, telephony device, network appliance, virtualization device, storage controller, etc. Any suitable CPU 506, GPU 509, and Operating Systems 530 may be used. Application Programs 536 and data in the internal memory 512 may be swapped into storage 515 as part of memory management operations.

As will be appreciated by one skilled in the art, aspects of the systems and methods herein may be embodied as a system, method, or computer program product. Accordingly, aspects of the present disclosure may take the form of an entirely hardware system, an entirely software system (including firmware, resident software, micro-code, etc.) or a system combining software and hardware aspects that may all generally be referred to herein as a “circuit,” “module”, or “system.” Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a Read-Only Memory (ROM), an Erasable Programmable Read-Only Memory (EPROM or Flash memory), an optical fiber, a magnetic storage device, a portable compact disc Read-Only Memory (CD-ROM), an optical storage device, a “plug-and-play” memory device, like a USB flash drive, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods, and computer program products according to various systems and methods herein. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular systems and methods only and is not intended to be limiting of this disclosure. As used herein, the singular forms “a”, “an”, and “the” are intended to include the plural forms as well, unless the context clearly indicates otherwise. It will be further understood that the terms “comprises”, “comprising”, “includes”, and/or “including”, when used in this specification, specify the presence of stated features, integers, steps, operations, elements, and/or components, but do not preclude the presence or addition of one or more other features, integers, steps, operations, elements, components, and/or groups thereof.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements).

While particular numbers, relationships, materials, and steps have been set forth for purposes of describing concepts of the systems and methods herein, it will be appreciated by persons skilled in the art that numerous variations and/or modifications may be made to the systems and methods as shown in the disclosure without departing from the spirit or scope of the basic concepts and operating principles of the concepts as broadly described. It should be recognized that, in the light of the above teachings, those skilled in the art could modify those specifics without departing from the concepts taught herein. Having now fully set forth certain systems and methods, and modifications of the concepts underlying them, various other systems and methods, as well as potential variations and modifications of the systems and methods shown and described herein will obviously occur to those skilled in the art upon becoming familiar with such underlying concept. It is intended to include all such modifications and alternatives insofar as they come within the scope of the appended claims or equivalents thereof. It should be understood, therefore, that the concepts disclosed might be practiced otherwise than as specifically set forth herein. Consequently, the present systems and methods are to be considered in all respects as illustrative and not restrictive.

The corresponding structures, materials, acts, and equivalents of all means or step plus function elements in the claims below are intended to include any structure, material, or act for performing the function in combination with other claimed elements as specifically claimed. The descriptions of the various systems and methods herein have been presented for purposes of illustration but are not intended to be exhaustive or limited to the systems and methods disclosed. Many modifications and variations will be apparent to those of ordinary skill in the art without departing from the scope and spirit of the described systems and methods. The terminology used herein was chosen to best explain the principles of the systems and methods, the practical application or technical improvement over technologies found in the marketplace, or to enable others of ordinary skill in the art to understand the systems and methods disclosed herein.

What is claimed is:

1. A computing system comprising:
a first central processing unit (CPU);
a first graphic processing unit (GPU) connected to the first CPU; and
a memory connected to the first CPU and the first GPU, the memory containing a first operating system and a second operating system,
wherein one of the first CPU and the first GPU operates a first application program using the first operating system as a base operating system, and
during operation of the first application program, the one of the first CPU and the first GPU suspends operation of the base operating system and dynamically transfers operation of the first application program to the second operating system.

2. The computing system according to claim 1, wherein the first operating system and the second operating system are selected from the group containing:
Linux OS,
Windows OS, and
Mac OS.

3. The computing system according to claim 1, wherein the one of the first CPU and the first GPU suspends operation of the base operating system for approximately 100 milliseconds.

4. The computing system according to claim 1, wherein the one of the first CPU and the first GPU dynamically transfers operation to the second operating system by swapping the base operating system into a storage state in the memory while preserving operation of the first application program.

5. The computing system according to claim 5, wherein the first application program comprises image processing.

6. The computing system according to claim 5, wherein the first application program comprises video processing.

7. The computing system according to claim 1, wherein the first central processing unit comprises a plurality of CPUs.

8. The computing system according to claim 1, wherein the first graphic processing unit comprises a plurality of GPUs.

9. A method of video processing, comprising:
operating a first video processing application program using a first operating system of a first processor for a computing device;
simultaneously operating a second video processing application program using a second operating system of a second processor for the computing device; and
dynamically suspending operation of one of the first processor and second processor to transfer operation of one of the first video processing application program and the second video processing application program to the remaining processor.

10. The method of video processing according to claim 9, wherein the first operating system and the second operating system are selected from the group containing:
Linux OS,
Windows OS, and
Mac OS.

11. The method of video processing according to claim 9, wherein the first processor comprises a central processing unit (CPU) and the second processor comprises a graphic processing unit (GPU).

12. The method of video processing according to claim 11, wherein the central processing unit comprises a plurality of CPUs.

13. The method of video processing according to claim 11, wherein the graphic processing unit comprises a plurality of GPUs.

14. The method of video processing according to claim 9, wherein suspending operation of one of the first processor and second processor comprises suspending operation of its operating system for approximately 100 milliseconds.

15. The method of video processing according to claim 14, further comprising:
swapping the suspended one of the first processor and second processor into a storage state in memory while preserving operation of the video processing application program,
changing operation of the suspended one of the first processor and second processor to a different operating system,
remapping the memory to the suspended one of the first processor and second processor, and
resuming operation of the one of the first processor and second processor using the different operating system.

16. A method, comprising:
operating a first video processing application program in a computer system having at least one central processing unit (CPU), at least one graphic processing unit (GPU), and memory storing instructions for execution by the at least one CPU and at least one GPU, wherein the instructions comprise a first operating system and a second operating system, the first video processing application program being operated on the at least one CPU;
simultaneously operating a second video processing application program in the computer system, the second video processing application program being operated on the at least one GPU;
dynamically suspending operation of one of the at least one CPU and the at least one GPU;
swapping the suspended one of the at least one CPU and the at least one GPU into a storage state in the memory;
changing operation of the suspended one of the at least one CPU and the at least one GPU to a different operating system;
remapping the memory to the suspended one of the at least one CPU and the at least one GPU; and
resuming operation of the one of the at least one CPU and the at least one GPU using the different operating system.

17. The method according to claim 16, wherein the first operating system and the second operating system are selected from the group containing:
Linux OS,
Windows OS, and
Mac OS.

18. The method according to claim 16, wherein the one of the at least one CPU and the at least one GPU suspends operation of its operating system for approximately 100 milliseconds.

19. The method according to claim 16, wherein swapping the suspended one of the at least one CPU and the at least one GPU into a storage state in the memory preserves operation of the video processing application program in its current state.

20. The method according to claim 16, wherein the at least one central processing unit comprises a plurality of CPUs and the at least one graphic processing unit comprises a plurality of GPUs.
